(19) United States
(12) Patent Application Publication
(10) Pub. No.: US 2005/0252537 A1
(43) Pub. Date: Nov. 17, 2005

(54) System for cleaning substrate

(76) Inventors: Hyun-Yul Park, Kyoungki-do (KR); Jong-Kon Bae, Kyoungki-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/128,922

(22) Filed: May 13, 2005

(30) Foreign Application Priority Data
May 17, 2004 (KR) 2004-34925

(51) Int. Cl. B08B 3/00

(52) U.S. Cl. 134/61; 134/104.1

(57) ABSTRACT

Disclosed is a system for cleaning a substrate such as a semiconductor wafer in wet type to thereby reduce airborne molecular contaminants (AMCs) in a wet station and a cleaning room by efficiently exhausting fumes generated during a wet cleaning process. The system for cleaning the substrate includes: a housing; a plurality of bathes placed inside of the housing; a transferring means placed on a top portion of the plurality of bathes for transferring a substrate; a first exhausting means connected to the plurality of bathes for exhausting fumes inside of the plurality of bathes; and a second exhausting means placed in a space inside of the housing and outside of the plurality of bathes for exhausting chemical fumes.

### FIELD OF THE INVENTION

The present invention relates to a system for cleaning a substrate such as a semiconductor wafer in wet type; and more particularly, to a system for reducing airborne molecular contaminants (AMCs) in a wet station and a cleaning room by efficiently exhausting fumes generated during a wet cleaning process.

### DESCRIPTION OF RELATED ARTS

As is known well, a substrate should be subjected to a wet cleaning process to continue a subsequent process after performing a series of steps such as depositing a thin layer, etching, polishing, and implanting ions. A wet station includes a plurality of bathes having different chemicals; and thus, the substrate is sequentially transferred to each bath closely placed with each other.

FIG. 1 is a diagram conceptually illustrating a conventional chemical mechanical polishing (CMP) wet station.

As shown, a plurality of bathes 102A, 102B, 102C and 102D are placed at a bottom portion of a housing 101. As for a substrate transferring device, a plurality of robot arms 103A, 103B, 103C, 103D and 103E are placed at a top portion inside of the housing 101 where is above the plurality of bathes 102A to 102D. Herein, the reference numerals from 102A to 102D express a first bath to a fourth bath, respectively. Also, the reference numerals from 103A to 103E express a first to a fifth robot arms, respectively. A substrate entrance enabled with opening and closing actions is formed on each of the first to the fourth bathes 102A to 102D. Thus, the first to the fifth robot arms 103A to 103E either put the substrate into the first to the fourth bathes 102A to 102D or take out the substrate from the first to the fourth bathes 102A to 102D through the substrate entrance.

Each of the first to the fourth bathes 102A to 102D contains chemicals based on each cleaning step. For instance, a standard clean 1 (SC1), i.e., a mixed solution of ammonium hydroxide (NH₄OH), hydrogen peroxide (H₂O₂) and deionized (DI) water, is contained in the first and the second bathes 102A and 102B. The third bath 102C contains NH₄OH, and the fourth bath 102D contains hydrogen fluoride (HF).

The first to the fifth robot arms 103A to 103E are controlled by a device controller. One selected robot arm 103A, 103B, 103C, 103D or 103E, for instance, the first robot arm 103A, is supposed to enter into the corresponding bath 102A, 102B, 102C or 102D, in this example, the first bath 102A at a set time and lift a cleaned substrate from the selected bath 102A. Then, the first robot arm 103A moves next and puts the substrate into another bath, i.e., the second bath 102B, next to the previous bath, i.e., the first bath 102A. Afterwards, the first robot arm itself 103A is taken out of the second bath 102B. By repeating this step, a cleaning process is completed after applying this step to the last bath, in this example, the fourth bath 102D.

The substrate taken out of the last bath, i.e., the fourth bath 102D, is transferred to a dry equipment 105 and becomes dry. It is general that the dry equipment 105 is placed beside the last bath in the housing of the wet cleaning device, thereby completing the cleaning process with the series of steps for cleaning in wet type and drying. A fan filter unit (FFU) 107 for blowing the air into the housing 101 is placed on an upper portion of the dry equipment 105. The fan filter unit (FFU) 107 serves a role in preventing particles from adsorbing on the substrate.

Meanwhile, an exhaust pipe 106 for draining the chemicals and exhausting the contaminants is interconnected to each of the first to the fourth bathes 102A to 102D. The conventional exhaust pipe 106 does not exist inside of the housing 101 for moving the first to the fifth robot arms but only being interconnected to each of the first to fourth bathes 102A to 102D.

Accordingly, the conventional cleaning device contains a plenty of airborne molecular contaminants (AMCs) inside of the housing. These contaminants are mostly produced due to an evaporation of the chemicals contained in the bathes and stained on the robot arms and the lifted substrate from the bathes.

Furthermore, the inside of the housing is not a closed space from the cleaning room, and thus, contamination of the cleaning room also becomes serious. Specifically, fumes are diffused into the cleaning room outside of the housing through a hole for putting the substrate into the housing and taking the substrate out of the housing and through a gap of the substrate entrance placed in the housing, and these diffused fumes induce a serious problem in cleanness of the cleaning room. Particularly, in case of containing the fan filter unit (FFU) inside of the cleaning device, it is very fast that the chemical components within the cleaning device leak to the cleaning room.

### SUMMARY OF THE INVENTION

It is, therefore, an object of the present invention to provide a method and system for cleaning a substrate capable of reducing airborne molecular contaminants (AMCs) in a wet station and a cleaning room by sufficiently exhausting fumes generated during a wet cleaning process.

In accordance with one aspect of the present invention, there is provided a system for cleaning a substrate, including: a housing; a plurality of bathes placed inside of the housing; a transferring means placed on a top portion of the plurality of bathes for transferring a substrate; a first exhausting means connected to the plurality of bathes for exhausting fumes inside of the plurality of bathes; and a second exhausting means placed in a space inside of the housing and outside of the plurality of bathes for exhausting chemical fumes.

In accordance with another aspect of the present invention, there is provided a system for cleaning a substrate installed inside of a cleaning room, including: a housing; a plurality of bathes placed inside of the housing; a transferring means placed on a top portion of the plurality of bathes for transferring a substrate; a first exhausting means connected to the plurality of bathes for exhausting fumes generated inside of the plurality of bathes out of the cleaning room; and a second exhausting means placed inside of the housing and outside of the plurality of bathes for exhausting chemical fumes out of the cleaning room.

### BRIEF DESCRIPTION OF THE DRAWINGS

The above and other objects and features of the present invention will become better understood with respect to the following description of the preferred embodiments given in conjunction with the accompanying drawings, in which:

FIG. 1 is a configuration diagram conceptually illustrating a cleaning device after performing a conventional chemical mechanical polishing process;

FIG. 2 is a configuration diagram briefly illustrating a cleaning device in accordance with a preferred embodiment of the present invention;

FIG. 3A is a perspective view illustrating a cleaning device shown in FIG. 2;

FIG. 3B is a perspective view illustrating a cleaning device in accordance with another preferred embodiment of the present invention;

FIG. 3C is a top view illustrating a cleaning device shown FIG. 3B; and

FIGS. 4A and 4B are graphs illustrating measurement results of ammonia (NH₃) concentration inside of a cleaning room and a cleaning device measured through employing a method for measuring airborne molecular contaminants (AMCs).

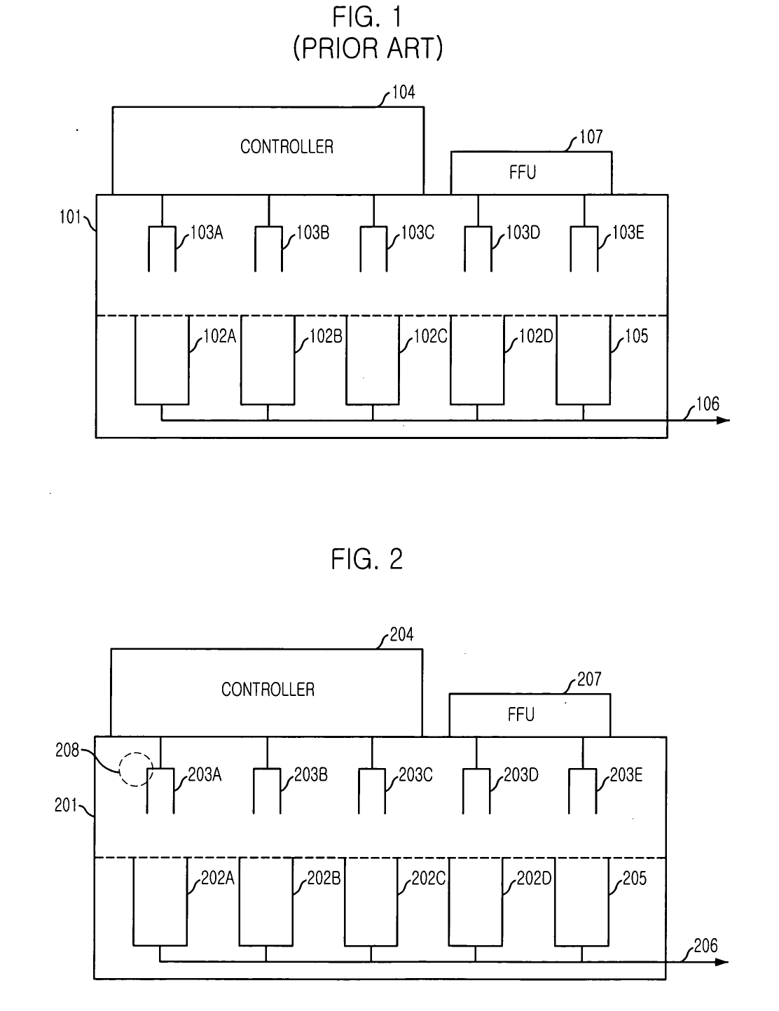

### DETAILED DESCRIPTION OF THE INVENTION

Hereinafter, detailed descriptions on a preferred embodiment of the present invention will be provided with reference to the accompanying drawings.

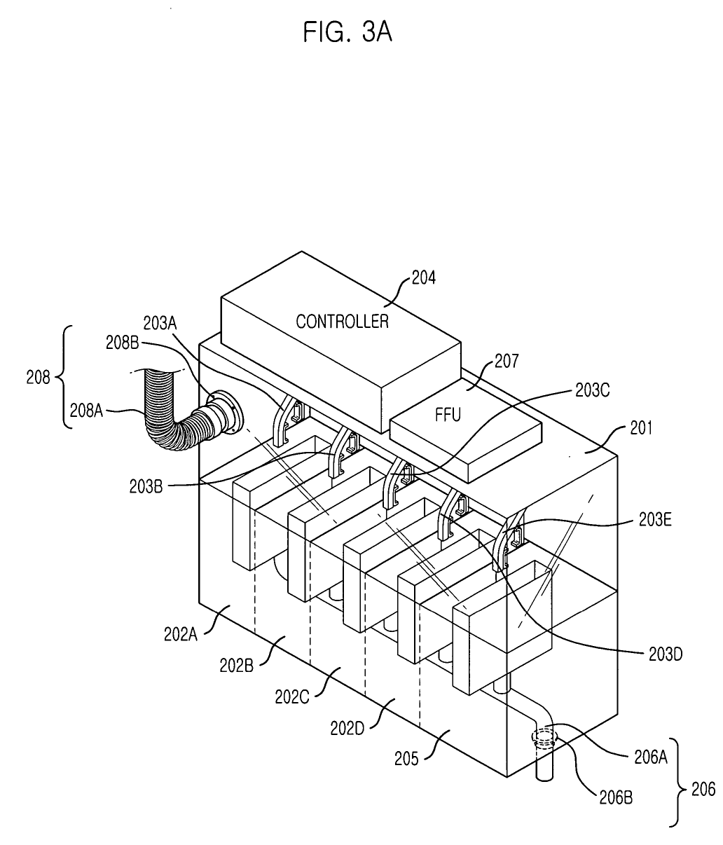

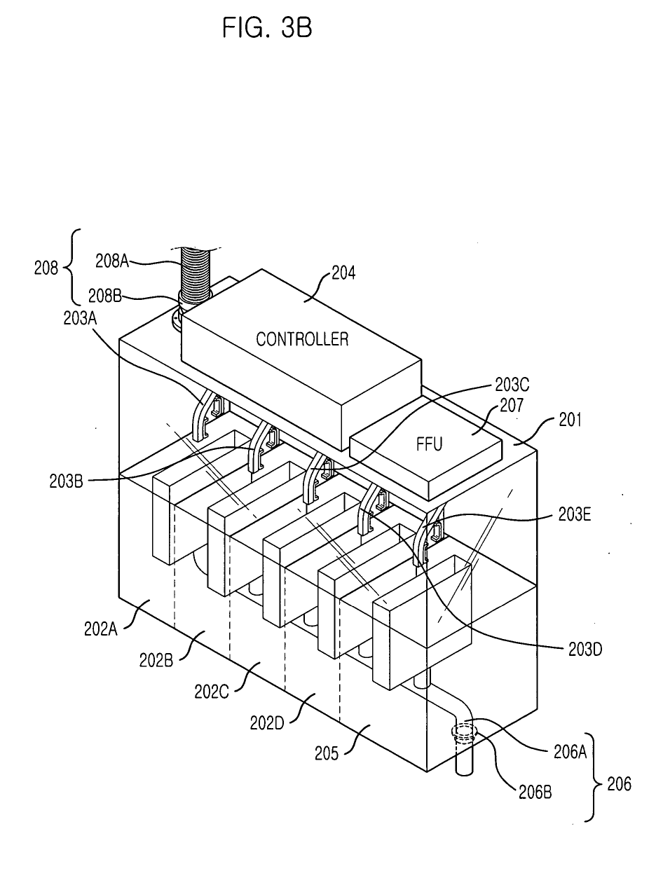

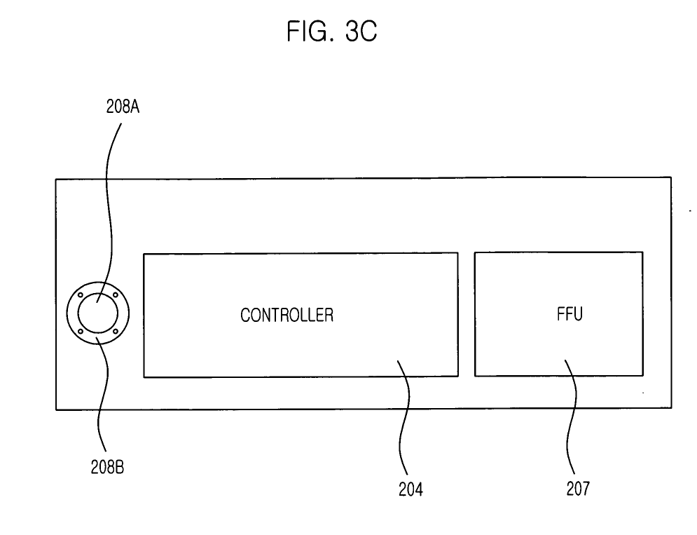

FIGS. 2 and 3A are a configuration diagram and a perspective view briefly illustrating a cleaning device in accordance with a preferred embodiment of the present invention, respectively.

Referring to FIGS. 2 and 3A, the cleaning device in accordance with the present invention includes a plurality of bathes 202A to 202D placed on a bottom portion of a housing 201 and a plurality of robot arms 203A to 203E on a top portion of the housing 201, where is above the plurality of bathes 202A to 202D. A substrate entrance enabled with opening and closing actions is formed on a top side of each of the bathes 202A to 202D. Thus, the plurality of robot arms 203A to 203E put the substrate into the corresponding bathes 202A to 202D and take the substrate out of the bathes 202A to 202D through the substrate entrance.

Each of the plurality of bathes 202A to 202D contains chemicals based on each sequential cleaning step. For instance, a standard clean 1 (SCl), i.e., a mixed solution of ammonium hydroxide (NH₄OH), hydrogen peroxide (H₂O₂) and deionized (DI) water, is contained in the bathes 202A and 202B. Herein, the reference numerals from 202A to 202D will be referred to as a first to a fourth bathes, respectively. The third bath 202C contains NH₄OH, and the fourth bath 202D contains hydrogen fluoride (HF).

The robot arms 203A to 203E are controlled by a device controller 204. Each of the robot arms 203A to 203E is supposed to enter into the corresponding first to fourth bathes 202A to 202D at a set time and lift a cleaned substrate from the selected bath 202A, 202B, 202C or 202D. Herein, it is assumed that the first robot arm 203A puts the substrate into the first bath 202A. Then, the first robot arm 203A moves next and puts the substrate into another bath, i.e., the second bath 202B, next to the previous bath, i.e., the first bath 202A. Afterwards, the first robot arm itself 203A is taken out of the second bath 202B. By repeating this step, a cleaning process is completed after applying this step to the last bath, in this case, the fourth bath 202D.

Each of the first to the fourth bathes 202A to 202D is interconnected to a first exhaust member 206 for draining the chemicals and exhausting the contaminants, wherein the first exhaust member 206 is provided with a first exhaust pipe 206A and a first exhaust outlet 206B.

The substrate taken out of the last bath is transferred to a dry equipment 205 and becomes dry. It is general that the dry equipment 205 is placed beside the last bath in the housing 201 of the wet cleaning device, thereby completing the cleaning process with the series of steps for cleaning in wet type and drying. A fan filter unit (FFU) 207 for blowing the air into the housing 201 is placed on an upper portion of the dry equipment 205. The fan filter unit (FFU) 207 serves a role in preventing particles from adsorbing on the substrate.

Most importantly, a second exhaust member 208 is formed for exhausting chemical fumes in an area inside of the housing 201 and outside of the first to the fourth 202A to 202D, wherein the second exhaust member 208 is provided with a second exhaust pipe 208A and a second exhaust outlet 208B. Typically, a process for fabricating a semiconductor device is performed in a cleaning room, and a cleaning device is also installed in the cleaning room. Thus, if the second exhaust pipe 208A is interconnected with a main exhaust pipe of the cleaning room, it is possible to exhaust the chemical fumes out of the cleaning room. Accordingly, it is further possible to improve a problem of airborne molecular contaminants generated inside of the cleaning room and the housing 201.

A second exhaust outlet 208B is made on one side of the housing 201 and then, the second exhaust pipe 208A is interconnected to the second exhaust outlet 208B. It is preferable that the second exhaust pipe 208A can be separated from the second exhaust outlet 208B of the housing 201 by considering maintenance of the equipment.

FIGS. 3B and 3C are a perspective view and a top view briefly illustrating a cleaning device in accordance with another preferred embodiment of the present invention, respectively. Herein, constitution elements of FIGS. 3B and 3C are denoted with the same numeral references as FIGS. 2 and 3A.

By considering that the air sectionally flows into the housing 201 due to the fan filter unit (FFU) 207, it is preferable to locate the second exhaust outlet 208B with which the second exhaust pipe 208A is interconnected in a place where the chemical fumes maintain a high concentration inside of the housing 201. Since the FFU 207 is placed on a top portion of the dry equipment 205, it is preferable to place the second exhaust outlet 208B on a top portion of the first bath 202A in opposition to the FFU 207.

Also, if necessary, it is possible to install a number of exhaust outlets and exhaust pipes in a number of places. Furthermore, it is possible to install at least one exhaust outlet and at least one exhaust pipe on a top side or/and a lateral side of the housing 201. However, in accordance with the present invention, since the device controller 204 is placed on the top side of the housing 201, the second exhaust outlet 208B and the second exhaust pipe 208A are installed on the lateral side of the housing 201 because the top side of the housing 201 does not have enough spaces. In case of changing a location and a size of the device controller 204, it is more preferable to install the second exhaust outlet 208B and the second exhaust pipe 208A on the top side of the housing than to install the second exhaust outlet 208B on the lateral side of the housing 201 in terms of efficiency on exhausting.

In accordance with the present invention, a size of the exhaust outlet ranges from approximately 100 Φ to approximately 200 Φ and the second exhaust pipe 208 is formed by using a polyvinyl chloride (PVC)-based hose that can be bended.

Furthermore, it is preferable to set an amount of the air exhausted through the second exhaust pipe 208 at a range from approximately 60% to approximately 70% of an amount of the air flowed into the housing 201.

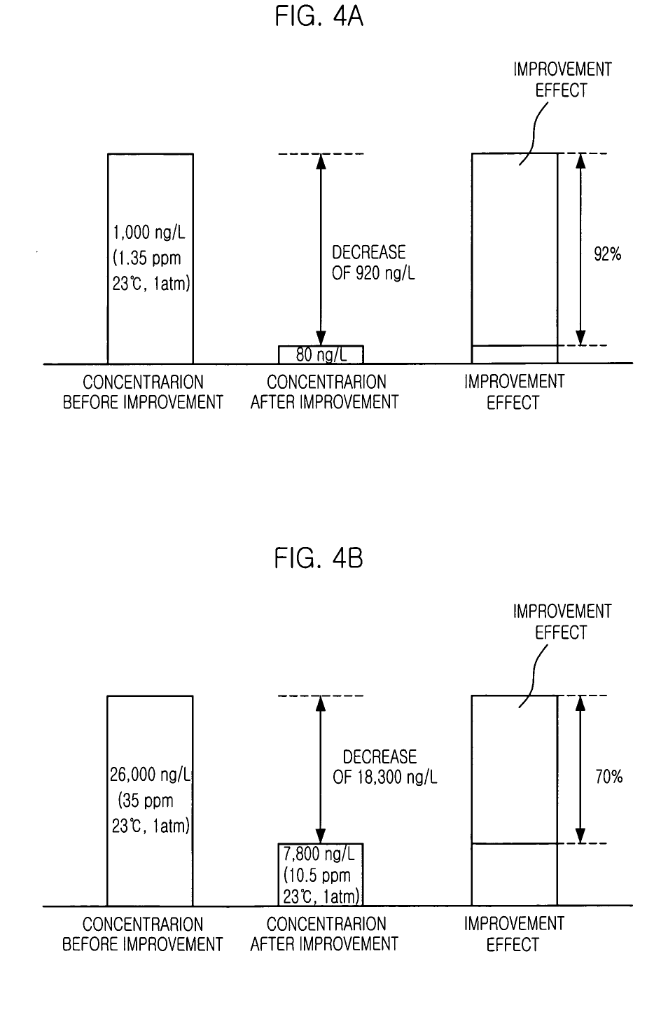

FIGS. 4A and 4B are graphs illustrating measurement results of ammonia (NH₃) concentration inside of a cleaning room and a cleaning device through employing a method for measuring airborne molecular contaminants (AMCs).

The airborne molecular contaminants (AMCs) are gaseous molecular substances being generated during fabricating a semiconductor device and acting as a contaminant degrading yields of a product. The AMCs affect not only a product but also a human body. However, the AMCs typically show approximately 1,000 times more sensitive reaction to the product than the human body depending on components of the product.

There are various methods for measuring the AMCs. However, among these various methods, it is widely used to sample contaminants with use of an impinger and then, analyze anions and cations first with use of an analysis apparatus, i.e., an ion chromatograph, and analyze boron, phosphorus and metallic components with use of an inductively coupled plasma-mass spectrometer (ICP-MS).

Particularly, ammonia (NH₃) among the AMCs acts as a main source for generating a defect in a photolithography process. Accordingly, the inside of the cleaning room should be maintained at approximately 1 ppb, i.e., 0.001 ppm. Ammonia (NH₃) also has a bad effect on the human body.

FIGS. 4A and 4B illustrate a fixed quantity obtained by first pouring ultra pure water (UPW) of approximately 50 mL into the impinger of approximately 70 mL, collecting the air into the ultra pure water as sucking the air of approximately 1 liter/min for more than approximately 5 hours with use of a sucking pump and then, analyzing the collected air with use of the ion chromatograph.

FIG. 4A shows the result of a measured concentration of ammonia (NH₃) inside of the cleaning room in which the cleaning device is installed. In case of installing the second exhaust pipe for exhausting the fumes inside of the housing 201, i.e., after an improvement, the concentration of ammonia (NH₃) is improved as much as approximately 92% compared with a state in which the first exhaust pipe directly interconnected to the first to the fourth bathes only exist, i.e., before the improvement. That is, the concentration of ammonia (NH₃) is approximately 1000 ng/L before the improvement; however, the concentration of ammonia (NH₃) is greatly decreased up to 80 ng/L after the improvement.

FIG. 4B shows the result of a measured concentration of ammonia (NH₃) dispersed inside of the housing of the cleaning device. As shown, compared with the concentration of ammonia (NH₃) before the improvement approximately 70% of ammonia (NH₃) concentration is obtained after the improvement.

The present invention efficiently reduces the airborne molecular contaminants (AMCs) inside of the cleaning device and the cleaning room, thereby minimizing an effect on a human body and preventing degradation of reliability and yields of products usually caused by the contamination in the substrate.

The present application contains subject matter related to the Korean patent application No. KR 2004-0034925, filed in the Korean Patent Office on May 17, 2004, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

1. A system for cleaning a substrate, comprising:
a housing;
a plurality of bathes placed inside of the housing;
a transferring means placed on a top portion of the plurality of bathes for transferring a substrate;
a first exhausting means connected to the plurality of bathes for exhausting fumes inside of the plurality of bathes; and
a second exhausting means placed in a space inside of the housing and outside of the plurality of bathes for exhausting chemical fumes.

2. The system for cleaning the substrate of claim 1, further including a fan filter unit (FFU) for blowing the air into a sectional region inside of the housing to prevent particles from adsorbing on the substrate.

3. The system for cleaning the substrate of claim 2, wherein the second exhausting means is placed where the chemical fumes have a high concentration inside of the housing due to the FFU.

4. The system for cleaning the substrate of claim 1, wherein the second exhausting means has a capacity of exhausting approximately 60% to approximately 70% of the air flowed in the housing.

5. The system for cleaning the substrate of claim 1, wherein the second exhausting means includes:
at least one exhaust outlet formed on one side of the housing; and
at least one exhaust pipe connected to the exhaust outlet and capable of being attached to and being detached from the housing.

6. The system for cleaning the substrate of claim 1, further including a dry means for drying the substrate completed with a cleaning process, the dry means being placed inside of the housing.

7. The system for cleaning the substrate of claim 5, wherein said at least one exhaust outlet is placed in one of a lateral side and a top side of the housing in which the chemical fumes have a high concentration inside of the housing due to the fan filter unit.

8. The system for cleaning the substrate of claim 7, wherein said at least one exhaust outlet placed on a top side of the housing is laid on a left side of a top portion of the housing beside the controller.

9. A system for cleaning a substrate installed inside of a cleaning room, comprising:
a housing;
a plurality of bathes placed inside of the housing;
a transferring means placed on a top portion of the plurality of bathes for transferring a substrate;
a first exhausting means connected to the plurality of bathes for exhausting fumes generated inside of the plurality of bathes out of the cleaning room; and
a second exhausting means placed inside of the housing and outside of the plurality of bathes for exhausting chemical fumes out of the cleaning room.

10. The system for cleaning the substrate of claim 9, further including a fan filter unit (FFU) for blowing the air into a sectional region inside of the housing to prevent particles from adsorbing on the substrate.

11. The system for cleaning the substrate of claim 10, wherein the second exhausting means is placed where the chemical fumes have a high concentration inside of the housing due to the FFU.

12. The system for cleaning the substrate of claim 9, wherein the second exhausting means has a capacity of exhausting approximately 60% to approximately 70% of the air flowed in the housing.

13. The system for cleaning the substrate of claim 9, wherein the second exhausting means includes:
at least one exhaust outlet formed in the housing; and
at least one exhaust pipe interconnected between a main exhausting pipe of the cleaning room and the exhaust outlet and capable of being attached to and detached from the housing.
